(19) United States
(12) Patent Application Publication
(10) Pub. No.: US 2024/0239416 A1
(43) Pub. Date: Jul. 18, 2024

(54) VEHICLE BODY PANEL INSERT

(71) Applicant: NISSAN NORTH AMERICA, INC., Franklin, TN (US)

(72) Inventors: Jose Adrian DELGADO HERNANDEZ, Toluca (MX); Jose Manuel RUIZ VILLEGAS, Toluca (MX); Enrique Carlos NIETO LOPEZ, Toluca (MX)

(21) Appl. No.: 18/153,735

(22) Filed: Jan. 12, 2023

(51) Int. Cl. B62D 25/20

(52) U.S. Cl. CPC B62D 25/20

(57) ABSTRACT

A vehicle body includes a first body panel, a second body panel and an insert. The second body panel is attached to an underside of the first body panel. The insert extends through the second body panel. The insert has a head, a shaft and a plurality of fins disposed along the shaft. The head is disposed on an exterior side of the second body panel. The shaft and the fins are disposed in a cavity between the second body panel and the first body panel. The insert further has an expandable foam provided on at least one of the shaft and one or more of the fins.

### BACKGROUND

### Technical Field

The present disclosure generally relates to a vehicle body panel insert. More specifically, the present disclosure relates to a vehicle body panel insert having an expandable foam.

### Background Information

Expandable materials can be designed to exhibit characteristics such as low weight, good adhesion, sound absorption, sound damping, relatively high levels of expansion, homogeneous expansion, consistent or predictable expansion or other desired characteristics. Expandable material can be combined with other components for forming a seal, a baffle, a structural reinforcement or the like in a cavity of an automotive vehicle.

### SUMMARY

In view of the state of the known technology, one aspect of the present disclosure is to provide a vehicle body comprises a first body panel, a second body panel and an insert. The second body panel is attached to an underside of the first body panel. The insert extends through the second body panel. The insert has a head, a shaft and a plurality of fins disposed along the shaft. The head is disposed on an exterior side of the second body panel. The shaft and the fins are disposed in a cavity between the second body panel and the first body panel. The insert further has an expandable foam provided on at least one of the shaft and one or more of the fins.

In view of the state of the known technology, one aspect of the present disclosure is to provide a method of sealing a cavity within a vehicle body. The method comprises attaching a first body panel to a second body panel. The method further includes inserting an insert having an expandable foam provided thereon through a first receiving opening of the second body panel. The method further comprises applying a predetermined temperature to the first and second body panels to bake the first and second body panels such that the expandable foam expands within a cavity between the first and second body panels.

### BRIEF DESCRIPTION OF THE DRAWINGS

Referring now to the attached drawings which form a part of this original disclosure:

FIG. 1 is a cross-sectional view of a portion of a vehicle body equipped with an insert in accordance with an illustrated embodiment;

FIG. 2 is an exploded view of the portion of the vehicle body showing a first, second and third body panels;

FIG. 3 is an enlarged cross-sectional view of the vehicle body of FIG. 1 to show the insert extending through the first, second and third body panels;

FIG. 4 is another enlarged cross-sectional view similar to FIG. 3;

FIG. 5 is a perspective view of a cavity formed between the first body panel and the first and second body panels with the insert extending into the cavity;

FIG. 6 is a plan view of an underside of the vehicle body;

FIG. 7 is an elevational view of the insert;

FIG. 8 is an elevational view of a first modified insert; and

FIG. 9 is an elevational view of a second modified insert.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

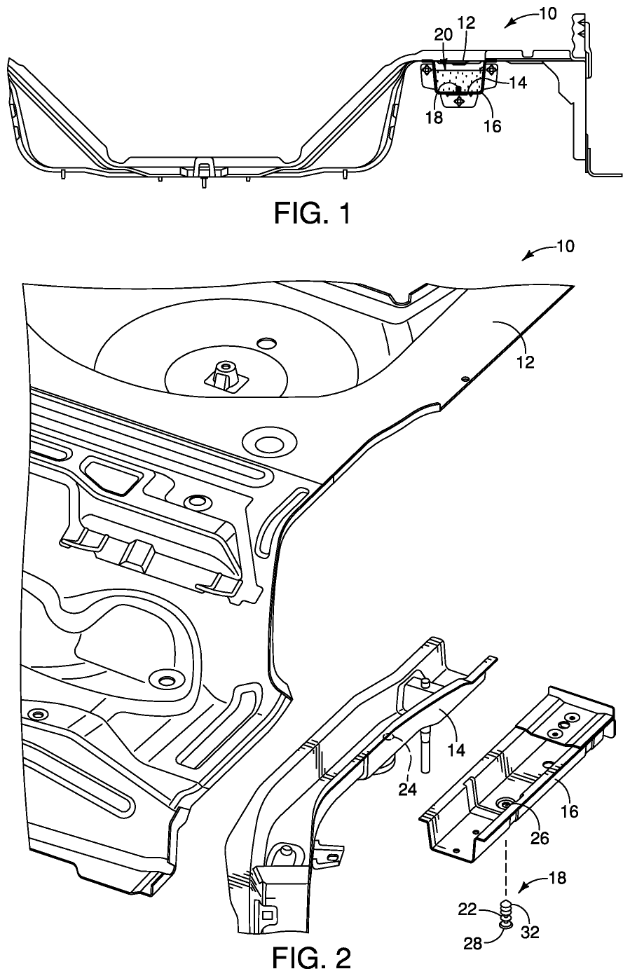

Referring initially to FIGS. 1 and 2, a portion of a vehicle body 10 of a vehicle is illustrated comprising a first body panel 12 and a second body panel 14. The vehicle body 10 further comprises a third body panel 16 and an insert 18. In the illustrated embodiment, the first body panel 12 is a vehicle floor panel. In the illustrated embodiment, the second body panel 14 is a U-shaped rail, and the third body panel 16 is also a U-shaped rail that is attached to the second body panel 14, as best seen in FIG. 2. Together, the second and third body panels 14 and 16 can form a bone-like structure to support the vehicle body 10 and the vehicle's components. The second and third body panels 14 and 16 are attached to an underside of the first body panel 12 such that a cavity 20 is formed therebetween, as seen in FIG. 2. The first, second and third body panels 12, 14 and 16 are metallic panels that are preferably made of sheet metal. Similarly, the first body panel 12 is a metallic panel that is preferably made of sheet metal.

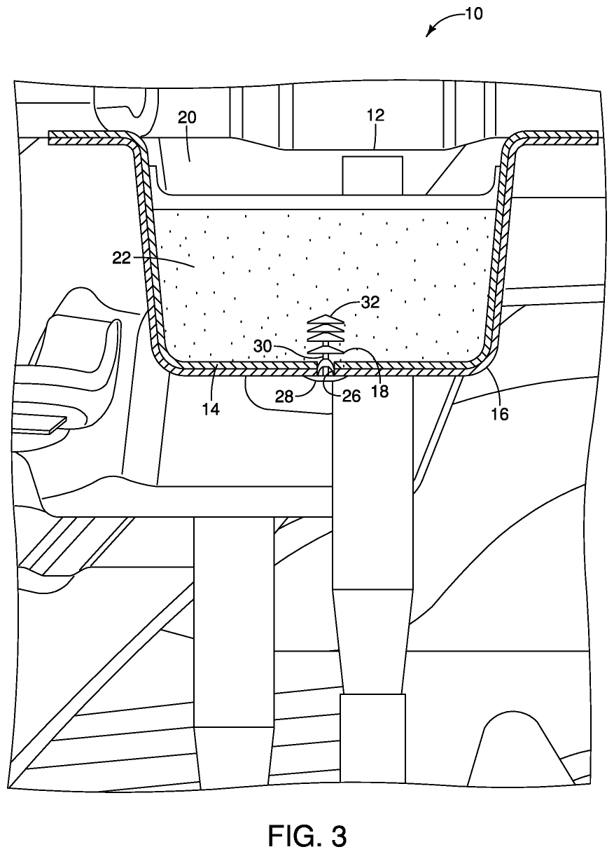

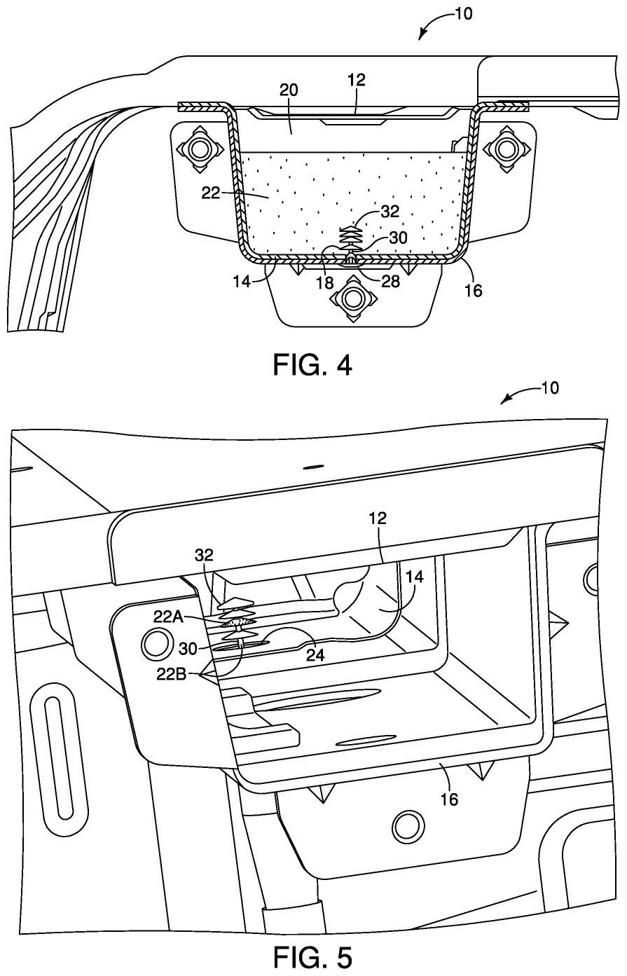

In the illustrated embodiment, the cavity 20 is formed between the second and third body panels 14 and 16 and the first body panel 12 when the three components are assembled to each other, as best seen in FIGS. 3 and 4. The cavity 20 is in communication with the exterior environment due to preexisting openings on the second and third body panels 14 and 16 that are used for aligning the second and third body panels 14 and 16. As a result, the vehicle's cabin is subject to receiving air via the cavity 20 and other such similar cavities in the vehicle body 10.

Therefore, in the illustrated embodiment, the insert 18 is provided with an expandable foam 22 that can expand in the cavity 20 to fill the cavity 20, as will be described below. It will be apparent to those skilled in the vehicle field from this disclosure that the insert 18 and the expandable foam 22 is not limited to the disclosed structures but can be applied to various types of vehicle panel attachment arrangements. The insert 18 can alternatively function as a clip or fastener for the vehicle body. It will be also apparent to those skilled in the vehicle field from this disclosure that the vehicle body 10 can be provided with a set of inserts 18 having expandable foam 22 having a function and structure similar to the insert 18 that is described herein.

As best seen in FIGS. 2 to 4, the second body panel 14 is attached to the underside of the first body panel 12. The second body panel 14 is a reinforcement panel for the vehicle body 10. Here, the term “underside” will refer a side below the referred structure as installed on a vehicle in an upright position. The third body panel 16 is attached to the underside of the first body panel 12 so to overlie the second body panel 14. Therefore, the second body panel 14 is positioned between the first body panel 12 and the third body panel 16. The second and third body panels 14 and 16 preferably have corresponding shapes such that the third body panel 16 is fitted over the second body panel 14. As shown, both the second and third body panels 14 and 16 are attached to the first body panel 12.

Referring to FIGS. 2, 3 and 6, the second body panel 14 includes a first receiving opening 24. The third body panel 16 includes a second receiving opening 26. The first and second receiving openings 24 and 26 are provided to receive positioning pins (not shown) that are used align the second and third body panels 14 and 16 together for welding. When the positioning pins are removed after welding, the cavity 20 is exposed to the exterior environment and subject to receiving air through the first and second receiving openings 24 and 26 which can then travel into the vehicle's cabin. Therefore, the insert 18 can be inserted into the cavity 20 and extends through the first and second receiving openings 24 and 26 when the positioning pin is removed. The expandable foam 22 on the insert 18 can expand in the cavity 20 to substantially fill the cavity 20 as will be further described below. It will be apparent to those skilled in the vehicle field from this disclosure that the first and second receiving openings 24 and 26 can also be provided as a drainage hole or other types of openings for other types of fasteners as needed and/or desired.

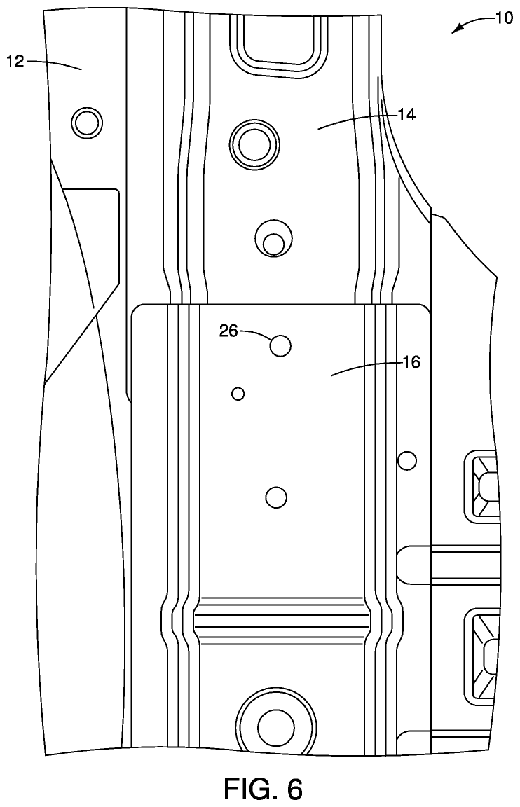

The insert 18 extends through the second body panel 14 and the third body panel 16 when in the installed state. The insert 18 has a head 28, a shaft 30 and a plurality of fins 32 disposed along the shaft 30. The head 28 is disposed on an exterior side of the second and third body panels 14 and 16, as best seen in FIG. 6. The shaft 30 and the fins 32 are disposed in the cavity 20 when the insert 18 is installed as seen in FIGS. 3 and 4. The cavity 20 is also positioned between the first body panel 12 and the third body panel 16 with the second body panel 14 positioned therebetween. The head 28 has a diameter that is greater than a diameter of the first and second openings. Therefore, when the shaft 30 extends through the first and second receiving openings 24 and 26, the head 28 is disposed on an opposite side of the second and third body panels 14 and 16 from the shaft 30.

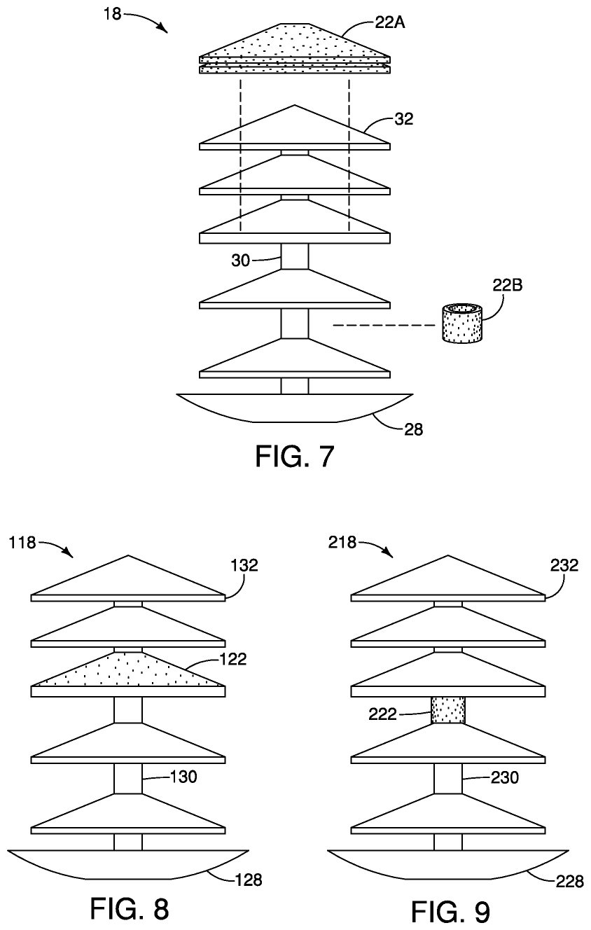

As shown in FIG. 7, the fins 32 are arranged along the length of the shaft 30. In the illustrated embodiment, the fins 32 are annular flanges that project radially outward with respect to the shaft 30. The insert 18 is illustrated as having a plurality of fins 32 provided in a series of layers along the shaft 30. However, it will be apparent to those skilled in the vehicle field from this disclosure that the insert 18 can include varying numbers of fins 32 as necessary or desired.

Preferably, the fins 32 have a maximum diameter that is less than the diameter of the head 28 for easy insertion of the fins 32 through the first and second receiving openings 24 and 26. The fins 32 are preferably made of a durable material with some degree of flexibility, such as nylon. In the illustrated embodiment, the fins 32 are preferably integrally formed with the shaft 30 and the head 28. Therefore, the shaft 30 and the head 28 are also preferably made of nylon.

The fins 32 are substantially rigid but can deform as the insert 18 is being inserted through the first and second receiving openings 24 and 26. The fins 32 then undeform into a fully expanded state when the insert 18 is fully inserted. The fins 32 are illustrated as being fan-like members or umbrella-like members on the shaft 30. However, it will be apparent to those skilled in the vehicle field from this disclosure that the size and shapes of the fins 32 are not limited to that disclosed.

As stated, in the illustrated embodiment, the insert 18 further includes the expandable foam 22 provided on at least one of the shaft 30 and one or more of the fins 32. As seen in FIGS. 2 and 3, The expandable foam 22 expands in the cavity 20 upon receiving a predetermined temperature. In the illustrated embodiment, the expandable foam 22 can expand at least 25 to 30 times its original size upon receiving the predetermined pressure. More preferably, the foam expands at least 30 times upon receiving the predetermined temperature.

Therefore, the expandable foam 22 is made of a heat-expandable material that can include polymer as a main component and a foaming agent for foaming the polymer. Examples of polymers that can be used as part of the foam can include ethylene-vinyl acetate copolymers, resins such as polyethylene, polypropylene, polyester, polyvinyl butyral, polyvinyl chloride, polyamide, and polyketone, and rubbers such as styrene-butadiene rubber (SBR) and polybutadiene rubber (BR). The predetermined temperature causes the foam to expand. As will be discussed below, applying the predetermined temperature causes the foam to expand to fill or substantially fill the cavity 20.

As best seen in FIGS. 7 to 9, the expandable foam 22 is provided on at least one of the fins 32. The expandable foam 22 can be applied to any one of the fins 32 by adhesive. As shown, the foam has a first foam part 22A that is provided on an upper surface of a top layer of one of the fins 32. The foam 22 has a second foam part 22B that is provided on a part of the shaft 30. Both the first and second foam parts 22A and 22B can expand radially outward with respect to the shaft 30 when heated. Therefore, the expandable foam 22 is radially provided on the insert 18 in a circumferential direction with respect to the shaft 30. In this way, the expandable foam 22 can expand in 360 degrees from the shaft 30 when heated. It will also be apparent to those skilled in the vehicle field from this disclosure that the expandable foam 22 can be provided on any of the other fins 32 or on two or more of the fins 32 concurrently.

The expandable foam 22 can be die cut into the desired shape and size from a sheet. Preferably, the expandable foam 22 is die cut into a size and shape that substantially corresponds to the fins 32. Alternatively, the expandable foam 22 can be sprayed onto the insert 18 at any desired location. Therefore, the foam can be dried liquid after being sprayed onto the fins 32. As stated, the foam is disposed on the fins 32 that are annularly arranged with respect to the shaft 30, the foam can expand in a radial direction with respect to the shaft 30 on all sides to fill the cavity 20. It will also be apparent to those skilled in the vehicle field from this disclosure that the expandable foam 22 can be provided partly on one side of a fin or the like to fill smaller or asymmetric cavities.

In the illustrated embodiment, the foam expands as part of the manufacturing or assembly process for the vehicle body 10. After the first, second and third body panels 12, 14 and 16 are attached, and welded, the insert 18 is inserted through the first and second receiving openings 24 and 26. The first, second and third body panels 12, 14 and 16 are then baked to further attach the first, second and third body panels 12, 14 and 16, along with other panels of the vehicle. Preferably, the baking process applies temperature at about 400 degrees F. This process helps make the body panels more dent-resistant. Therefore, the predetermined temperature is preferably approximately 400 degrees F. The predetermined temperature is at least 350 degrees F.

Therefore, a method of sealing the cavity 20 within the vehicle body 10 comprises attaching the first body panel 12 to the second body panel 14. The method further comprises aligning the first receiving opening 24 of the second body panel 14 with the second receiving opening 26 of the third body panel 16. The method further comprises attaching a third body panel 16 to the second body panel 14 so to overlie the second body panel 14. The method further comprises inserting the insert 18 having through the first receiving opening 24 of the second body panel 14. The method further comprises inserting the insert 18 through the second receiving opening 26 as the first and second receiving openings 24 and 26 are aligned.

The insert 18 extends through the second receiving opening 26 of the third body panel 16 as the insert 18 is inserted through the second and third body panels 14 and 16. The method further comprises applying a predetermined temperature to the second body panel 14 and the first body panel 12 to bake the second body panel 14 and the first body panel 12. In this way, the expandable foam 22 expands within the cavity 20 between the second body panel 14 and the first body panel 12. The method further comprises inserting applying the predetermined temperature to the first and second body panels 12 and 14. This step of the method includes applying the predetermined temperature to the third body panel 16 so to bake the first body panel 12 and the second and third body panels 14 and 16 together.

Referring to FIGS. 8 and 9, a first modified insert 118 and a second modified insert 218 are illustrated that can be implemented with the first, second and third body panels 12, 14 and 16 of the vehicle. The first modified insert 118 is identical to the insert 18 of FIG. 7, except that the first modified insert 118 includes an expandable foam 122 that is provided on a different one of the fins 132 in FIG. 8. Due to the similarities between the first modified insert 118 and the insert 118, the corresponding components of the first modified insert 118 will receive the same reference numerals as the insert 18 but increased by 100.

The second modified insert 218 is identical to the insert 18 of FIG. 7, except that the second modified insert 218 includes an expandable foam 222 that is provided on a shaft 230 in FIG. 9. Due to the similarities between the second modified insert 218 and the insert 18, the corresponding components of the second modified insert 218 will receive the same reference numerals as the insert 18 but increased by 200.

In understanding the scope of the present invention, the term “comprising” and its derivatives, as used herein, are intended to be open ended terms that specify the presence of the stated features, elements, components, groups, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the vehicle body panel insert. Accordingly, these terms, as utilized to describe the present invention should be interpreted relative to a vehicle equipped with the vehicle body panel insert.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device that is constructed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle body comprising:
a first body panel;
a second body panel attached to an underside of the first body panel; and
an insert extending through the second body panel, the insert having a head, a shaft and a plurality of fins disposed along the shaft, the head being disposed on an exterior side of the second body panel and the shaft and the fins being disposed in a cavity between the second body panel and the first body panel, the insert further having an expandable foam provided on at least one of the shaft and one or more of the fins.

2. The vehicle body according to claim 1, further comprising
a third body panel attached to the underside of the first body panel so to overlie the second body panel, the head of the insert being disposed on an exterior side of the third body panel.

3. The vehicle body according to claim 2, wherein
the expandable foam expands in the cavity upon receiving a predetermined temperature.

4. The vehicle body according to claim 3, wherein
the expandable foam is provided on at least one of the fins.

5. The vehicle body according to claim 4, wherein
the expandable foam is provided on the shaft.

6. The vehicle body according to claim 5, wherein
the first body panel is a vehicle floor panel.

7. The vehicle body according to claim 6, wherein
the second body panel is a U-shaped rail.

8. The vehicle body according to claim 7, wherein
the third body panel is a U-shaped rail.

9. The vehicle body according to claim 7, wherein
the foam expands at least 30 times upon receiving the predetermined temperature.

10. A method of sealing a cavity within a vehicle body, the method comprising
attaching a first body panel to a second body panel;
inserting an insert having an expandable foam provided thereon through a first receiving opening of the second body panel; and
applying a predetermined temperature to the first and second body panels to bake the first and second body panels such that the expandable foam expands within a cavity between the first and second body panels.

11. The method according to claim 10, further comprising
attaching a third body panel to the second body panel so to overlie the second body panel.

12. The method according to claim 11, further comprising
aligning the first receiving opening of the second body panel with a second receiving opening of the third body panel.

13. The method according to claim 12, further comprising
inserting the insert through the first and second receiving openings.

14. The method according to claim 13, wherein
applying the predetermined temperature to the first and second body panels also includes applying the predetermined temperature to the third body panel so to bake the first body panel and the second and third body panels together.

15. The method according to claim 14, wherein
the cavity is disposed between the second and third body panels and the first body panel.

16. The method according to claim 15, wherein
the first body panel is a vehicle floor panel.

17. The method according to claim 16, wherein
the second body panel is a U-shaped rail.

18. The method according to claim 17, wherein
the third body panel is a U-shaped rail.
